(19) United States
(12) Patent Application Publication
(10) Pub. No.: US 2007/0065668 A1
(43) Pub. Date: Mar. 22, 2007

(54) Work with multi layers coating films and method of forming multi layers coating films

(75) Inventor: Hiroshi Idei, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: AKEBONO BRAKE INDUSTRY CO., LTD.

(21) Appl. No.: 11/524,269

(22) Filed: Sep. 21, 2006

(30) Foreign Application Priority Data
Sep. 22, 2005 (JP) P.2005-275893
Aug. 15, 2006 (JP) P.2006-221516

(51) Int. Cl. B32B 27/20; B05D 1/12; B05D 3/02

(52) U.S. Cl. 428/411.1; 427/180; 427/402; 427/372.2

(57) ABSTRACT

A work to be coated with multi layers of coating films, is provided with a first layer of coating film formed by coating a powder coating material of a thermosetting resin containing an electroconductive filler and an elastomer on a surface to be coated on the work; and a second layer of coating film formed by coating a powder coating material of a thermosetting resin containing water repellent particles on the first layer of coating film. The first layer of coating film and the second layer of coating film are baked by heating. It is preferable that the work is a friction member including a metal pressure plate and a friction material.

This application claims foreign priority from Japanese Patent Application Nos. 2005-275893, filed on Sep. 22, 2005, and 2006-221516, filed on Aug. 15, 2006, the entire contents of which are hereby incorporated by reference.

### BACKGROUND OF THE INVENTION

1. Field of the Invention

The present invention relates to a work such as metallic member to be coated with coating films and a method of forming coating films on a work to be coated. More in particular, it relates to a work formed with coating films on a metallic member of a braking member used, for example, in industrial machines, railway vehicles, cargo vehicles, passenger cars, etc. and a method of forming the coating films on the work. More specifically, it relates to a work such as a metallic member to be formed with coating films and a method of forming the coating films on the work, in a friction member used in the applications described above.

2. Related Art

Conventionally, in order to improve a corrosion resistance and a weather resistance, it is widely used to form a coating film on a metallic member. As a method of forming the coating film, various methods including a spray coating, an immersion coating, an electrophoretic coating, a powder coating, and so on are known. In the methods, methods for using coating compositions including a solvent require a step of recovering the solvent. However, since the step of recovering the solvent has problems such as safety, the methods for using coating compositions including the solvent are going to be changed to another methods. In the methods, since the powder coating does not use the solvent, needs simple steps, and is able to recover powder which is not coated in a coating step, the powder coating has a merit such as a cost reducing. However, a continuous coating film is formed by welding powder particles to each other by heating and baking, after a coating layer is formed by adhering powder bodies on a surface of a metallic member. Therefore, it is difficult to obtain a complete covering coating film.

For example, in a powder coating of a friction member (brake pad), a powder coating material of an epoxy resin or epoxy-polyester resin type has been used so far, for example, as disclosed in JP-A-2004-27035. However, this involves a problem that corrosion resistance and close adhesion are not sufficient and this is not sufficient also for the noise characteristic caused from the friction member (brake pad) as a source of vibrations in view of the poor flexibility and damping characteristic. Referring to the corrosion resistance, aside from the corrosion resistance of the bonding surface per se, there is a possibility in the market that adhesion peeling due to rust at the bonding surface when a water content intruding from a dove-tail groove of the friction member (binding hole for molding) the lateral surface of a friction member reaches the bonding surface, or adhesion peeling due to growing of rust generated at the periphery of the bonded portion for the friction member where the friction material is not present and intrusion thereof to the bonding surface, and a countermeasure in districts suffering from salt damages such as North American Area results in a significant problem in the future.

It is an object of the present invention to provide a work to be coated such as a metallic member and a method of forming a coating film of the work for a coating film with an excellent corrosion resistance and a weather resistance, in which a film that elastomer particles is dispersing is obtained by a powder coating.

### SUMMARY OF THE INVENTION

In accordance with one or more embodiments of the present invention, a work to be coated with multi layers of coating films is provided with: a first layer of coating film formed by coating a powder coating material of a thermosetting resin containing an electroconductive filler and an elastomer on a surface to be coated on the work; a second layer of coating film formed by coating a powder coating material of a thermosetting resin containing water repellent particles on the first layer of coating film, wherein the first layer of coating film and the second layer of coating film are baked by heating.

Further, the work may be a friction member comprising a metal pressure plate and a friction material.

In accordance with one or more embodiments of the present invention, a method of forming multi layers of coating films on a work to be coated, the method is provided with the steps of: forming a first layer of coating film by coating a powder coating material of a thermosetting resin containing an electroconductive filler and an elastomer on a surface to be coated on the work; forming a second layer of coating film by coating a powder coating material of a thermosetting resin containing water repellent particles on the first layer of coating film; and baking the first layer of coating film and the second layer of coating film by heating.

Further, the step of forming the first layer of coating film may be conducted by electrostatic coating on the surface of the work by using an epoxy resin type powder coating material containing particles of one or more of metals such as aluminum and zinc, carbon black, and particles of metal oxides such as zinc oxide and titanium oxide as the filler.

Further, the step of forming the second layer of coating film may be conducted by electrostatic coating on the first layer of the coating film by using an epoxy resin type powder coating material containing one or more of polytetrafluoroethylene and polytrifluoroethylene as the water repellent particles.

According to the method of forming multi layers of coating films on a work to be coated and the work of one or more embodiments of the present invention, in which the first layer of coating film comprising an electroconductive filler and elastomer particles dispersed therein and the second layer of coating film comprising water repellent resins dispersed therein, a coated work excellent in the close adhesion of the coating film, corrosion resistance, weather resistance and vibration proofness of a coated film can be produced and adhesion peeling caused by rust during use can be prevented. When a metallic pressure plate of a braking member in which a friction member is adhered to the metallic pressure plate is provided with coating films formed by the multi coating films forming method, not only it is excellent in the close adhesion of the coating film, corrosion resistance, weather resistance and vibration proofness, but also it is improved in a noise characteristic caused by the friction material as a source of vibration.

Other aspects and advantages of the invention will be apparent from the following description and the appended claims.

### BRIEF DESCRIPTION OF THE DRAWINGS

FIG. 1 is a schematic view showing a cross sectional layer constitution of a friction member (brake pad).

### DETAILED DESCRIPTION OF THE EXEMPLARY EMBODIMENTS

Exemplary embodiments of the invention will be described with reference to the accompanying drawings. In the exemplary embodiments, a work to be coated with multi layers of coating films and a method of forming multi layers of coating films on a work to be coated of the present invention is applied to a friction member for a brake apparatus, as example in order to explain the present invention.

In the drawing for explaining the exemplary embodiments and examples, constituent factors having identical functions are described with reference to identical reference numerals.

Production of a friction material for use in brakes is generally conducted by way of each of the steps of blending, stirring, preliminarily molding a starting material of a friction member at a normal temperature, thermal forming, thermal treatment and finishing such as grinding.

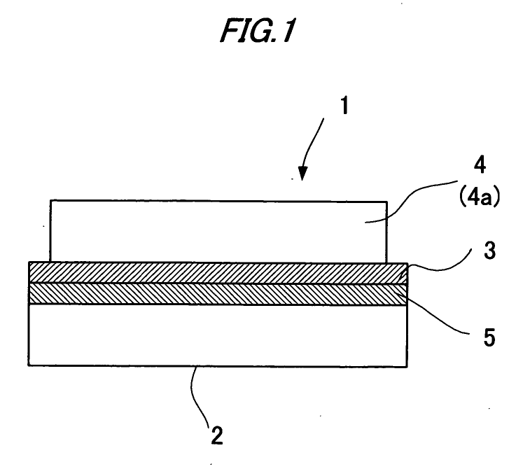

At first, each of the steps is to be described for an illustrated example of a friction pad for a disk brake as a friction member 1. FIG. 1 is across sectional view of a friction member 1 in which a friction material 4 is integrated by press molding by way of an adhesive 3 to a pressure plate 2 coated with a primer 5 (hereinafter referred to as “P/P”) P/P is fabricated by each of the steps of sheet metal pressing, degreasing treatment, primer treatment and P/P preheating as the main step. In the steel sheet metal pressing step, a previously selected P/P raw material is molded into P/P of a predetermined shape by pressing or the like. In the degreasing step, oils and fats deposited to P/P upon pressing are removed by using a detergent. In the primer treating step, a resin primer is spray coated over the entire surface of degreased P/P, dried, heated at 180 to 200° C. for about one hour and the primer is hardened to form a primer layer. For the primer 5, usual primers can be used and include, for example, vinyl/phenol resin (polyvinyl acetal, polyvinyl formal, polyvinyl butyral, and copolyamide as vinyl elastomer), nitrile rubber/phenol resin, silane type resin (for example, γ-aminopropyltriethoxy silane), and urethane type primer.

On the other hand, the preliminary molding of the friction material 4 includes metering, blending, stirring, and preliminary molding of the starting materials as the main step. Each of the steps described above can be in accordance with the existent production technique for the friction material. For example, a starting material is prepared by blending reinforcing fibers such as heat resistant organic fibers, inorganic fibers, and metal fibers with a powdery starting materials such as inorganic fillers, a friction controlling material, solid lubricant and thermosetting resin binder each at a predetermined ratio and sufficiently homogenizing them by mixing and stirring. In the foregoings, the reinforcing fibers include, for example, organic fibers such as aromatic polyamide fibers, flame resistant acrylic fibers, metal fibers such as copper fibers and steel fibers, and inorganic fibers such as potassium titanate fibers and Al₂O₃—SiO ceramic fibers. The inorganic filler includes, for example, inorganic particles such as barium sulfate and calciumcarbonate, and flaky inorganic materials such as vermiculite or mica. The thermosetting resin binder includes and, for example, phenol resins (including straight phenol resin, various kinds of modified phenol resins with rubber), melamine resin, epoxy resin, and polyimide resin. Further, the friction controlling material includes, for example, inorganic friction control materials such as alumina, silica, magnesia, zirconia, and chromiumoxide, organic friction controlling materials such as synthetic rubber and cashew resin. The solid lubricant includes, for example, graphite or molybdenum disulfide. For the composition of the friction material, various ratio can be adopted for the composition. That is, the materials may be used alone or two or more of them may be blended in combination in accordance with friction characteristics required for products, for example, friction coefficient, wear resistance, vibration characteristic and noise characteristic.

Then, the starting materials are charged in a molding die and molded at a pressure of about 10 to 100 MPa of surface pressure to prepare a preliminary molding product 4a of a friction member as shown, for example, in FIG. 1. The preliminary molding product 4a comprising P/P and the friction material treated as described above is transferred to a thermoforming step. In the thermoforming step, a preliminarily heated P/P is at first set being kept at a high temperature in a press machine, on which the preliminary molding product 4a is placed and thermally formed.

A powder coating is adopted for coating in the invention. The powder coating includes an electrostatic coating method and a fluidized dipping method. In the electrostatic coating method, according to the principle of the electrostatic coating method using the powder coating, powder particles are charged by a high DC voltage obtained by a high static voltage generator and they are deposited by electrostatic attraction to an article to be coated which is grounded to the earth. The coating material coated to an work to be coated is heated in a baking furnace, melted and then hardened to form a continuous film. Over-sprayed powder coating material is recovered and utilized again. The electrostatic coating method by the powder coating is generally classified into two types.

<a. Electrostatic Spraying Method>

A powder coating material is sent pneumatically from a coating supply tank to a spray gun. Further, the powder coating is charged negatively by a high voltage obtained from the high static voltage generator (usually at −40 KV to −90 KV). On the other hand, the work to be coated work is grounded to the earth and the powder coating material discharged from the gun top end is deposited to the surface of the work to be coated by electrostatic attraction. In this case, the negatively charged powder particles exert intensely on a portion at high potential to be deposited on the work to be coated. As they are deposited thickly, negative charges are accumulated to the coating film and result in electrostatic repulsion at a larger predetermined thickness and become less depositing. The powder coating material not flying straightly to the work to be coated partially drifts around back and is deposited. A uniform coating film is obtained to a certain thickness by the phenomenon described above and the film thickness is also limited. Further, the triboelectric spray coating applying the principle of triboelectricity is a coating method having an advantage, for example, in that it requires no high voltage generator, shows good turning around property or intruding property and generates less electrostatic repulsion.

<b. Electrostatic Dipping method>

A bottom plate of a dipping tank for filling a powder coating material is formed of a porous plate and electrodes are arranged each at a predetermined distance. The powder coating material in the tank is fluidized by air blowing upward of the porous bottom plate. On the other hand, a high voltage at −40 KV to −90 KV is applied from a high static voltage generator to the electrodes and ionized powder particles suspending in air are charged negatively and scattered upward in the tank and are deposited to the object which is grounded to the earth. Particles not deposited on the work to be coated are gravitationally fallen and then again ascend as charged particles and repeat movement for re-deposition to the work to be coated.

The fluidized dipping method is a method of pneumatically fluidizing the powder in a fluidizing tank having a porous plate placed at the bottom, dipping a preheated work to be coated in the suspending powder and heat melting the powder deposited to the work surface thereby forming a continuous film.

Since the method requires no particular equipment, the installation cost is relatively inexpensive, with scarce coating loss occurs scarcely, and a coating film at a large film thickness of 250 μm to 1000 μm and excellent in the edge coverability can be obtained easily. However, the size and shape of the work to be coated are restricted and requires preheating of the work to be coated (150 to 300° C.) is required as an essential condition.

The powder coating composition used in the invention has an average particle size for the particles of from 15 to 35 μm in which 30 mass % or less of particles have the particle size of 50 μm or more. More preferably, 5 mass % or less of particles have the particle size of 100 μm or more and 15 mass % or less of particles have the particle size of 5 μm or less. By making the average particle size smaller and making the particle size uniform as described above, the coating thickness is reduced and scorching processability is excellent.

The powder coating resin used for the powder coating material includes acryl resin, epoxy resin, and polyester resin, and a powder coating material comprising a thermosetting epoxy resin or a thermosetting epoxy resin—polyester resin as a main ingredient is preferred in this invention.

The polyester resin (A) used for the powder coating material of the invention is a resin having an ester bond of —C(O)O— and it is generally formed by dehydrating condensation between a compound having an alcohol group (—ROH group) and a compound having a carboxyl group (—COOH group).

The blending amount of the polyester resin in a case of using the thermosetting epoxy resin/polyester resin is from 10 to 90 mass % and, preferably, from 20 to 50 mass % based on the entire weight of the composition.

Usually, the polyester resin is formed, for example, by polymerizing a polyhydric alcohol such as ethylene glycol, propane diol, hexane diol, neopentyl glycol, trimethylol propane, or pentaerythritol, and a carboxylic acid such as maleic acid, terephthalic acid, isophthalic acid, phthalic acid, succinic acid, glutaric acid, adipic acid, sebatic acid, or β-oxypropionic acid in accordance a customary method.

In the invention, the polyester resin is not particularly restricted so long as it is used generally as a resin for powder coating, and the average molecular weight is, preferably, from 500 to 100,000 and, more preferably, from 2,000 to 80,000. The OH value is from 0 to 300 mg KOH/g, preferably, from 30 to 120 mg KOH/g. Further, the acid value is from 0 to 200 mg KOH/g, preferably, from 10 to 100 mg KOH/g. The melting point is, preferably, from 50 to 200° C. and, more preferably, from 80 to 150° C.

Specifically, the polyester resin includes, for example, “Crylcoat 341, 7620, 7630” manufactured by Daicel UCD Co., “FinedickM-8010, 8020, 8024, 8710” manufactured by Dai-Nippon Ink and Chemicals Inc., “Kopika coat GV110, 230” manufactured by Nippon Kopika Co., “ER6570” manufactured by Nippon Ester Co., and “VESTAGON EP-P100” manufactured by Hules Co.

Specific examples of the epoxy resin includes glycidyl ester resin; glycidyl ether type resin such as condensating reaction product of bisphenol A and epichlorohydrin or condensating reaction product of bisphenol F and epichlorohydrin; cycloaliphatic epoxy resin; aliphatic epoxy resin; bromine-containing epoxy resin; phenol-novolac type or cresol-novolac type epoxy resin, etc. Glycidyl ether type resin such as condensating reaction products of bisphenol A and epichlorohydrin, or condensating reaction products of bisphenol F and epichlorohydrin are preferred.

Specifically, they include “Epototo YD903N, YD128, YD14, PN639, CN701, NT114, ST-5080, ST-5100, ST-4100D” manufactured by Toto Kasei Co., “EITPA3150” manufactured by Daicel Chemical Industries Ltd., “Ardite CY179, PT810, PT910, GY6084” manufactured by Ciba Geigy Co., “Tekonal EX711” manufactured by Nagase Kasei Co., “Epicron 4055RP, N680, HP4032, N-695, HP720OH” manufactured by Dai Nippon Ink and Chemicals Inc., “Epicoat 1001, 1002, 1003, 1004, 1007” manufactured by Yuka Shell Epoxy Co., “DER662” manufactured by Dow Chemical Co., and “EPPN201, 202, EOCN1020, 102S” manufactured by Nippon Kayaku Co.

Further, the hardening agent used for the powder coating material of the invention includes blocked isocyanate type, triglycidyl isocyanate (TGIC) type, epoxy type (polyethoxide, epoxy resin), etc. Blocked isocyanate type is particularly preferred.

The blocked isocyanate type hardening agent is formed of a compound mainly comprising urethane bonds (—NHCO—). In the blocked (poly) isocyanate used in the invention, isocyanate groups of the (poly)isocyanate compound are blocked with a blocking agent. The softening point ranges from 20 to 100° C. and preferably, from 25 to 80° C., and the ratio of NCO (%) is preferably about 5 to 30%.

A pigment or a body pigment blended properly with the coating composition of the invention includes coloring pigments such as titanium oxide, red iron oxide, iron oxide, carbon black, phthalocyanine blue, phthalocyanine green, quinacridone type pigment and azo type pigment, body pigments such as talc, silica, alumina, calcium carbonate, and precipitating barium sulfate, or anti-rusting pigments such as chromium type pigment, phosphate type pigment and molybdenum type pigment.

Further, leveling agent optionally blended properly (surface controlling agent) includes silicones such as dimethyl silicone and methyl silicone and acryl oligomer, etc. and include specifically, “CF-1056” manufactured by Toshiba Silicone Co., “Modaflow” manufactured by Monsant Kasei Co., “Acronal 4F” manufactured by BASF Co., “BYK-360P” manufactured by BYK Chemie Co., and “DISPARLON PL540” manufactured by Kusumoto Chemicals Ltd.

Then, an embodiment of a work to be coated with multi coating films and a method of forming multi coating films on the work are to-be described more specifically.

In the coating of a friction member (brake pad) as the work comprising a metal pressure plate and a friction material, a first coating film is formed by electrostatically coating a powder coating material of a thermosetting resin containing an electroconductive filler and an elastomer to the surface of the pressure plate to be coated. Then, a powder coating material of a thermosetting resin containing water repellent particles are electrostatically coated on the first layer of coating film to form a second layer of coating film. Finally, the friction member is heated and baked.

The resin as a matrix for the first layer film is an epoxy resin or an epoxy resin-polyester resin which contains a hardening agent, a pigment, an anti-blocking agent, etc., and the composition and the addition amount thereof can be properly decided by those skilled in the art. The filler as an electroconductive filler includes aluminum and zinc as a metal type and a submicron order particle size is preferred. The filler includes carbon black as a carbon type having a particle size from 10 to 200 nm and a specific surface area of from 50 to 1000 m²/g. The filling effect is better as the particle size is smaller and the specific surface area is larger. The filler includes zinc oxide and titanium oxide as the oxide type, and the preferred particle size is from 0.1 to 2 μm. However, since the filler functions also as a colorant, it should be selected so as to conform the tone. At the addition amount with in a range from 10 to 60mass %, powder coating material for the second layer film can be coated electrostatically with no problem in view of coloration. It is preferably 20 mass % or more for those excluding carbon black and 3 mass % or more for carbon black. The elastomer particles dispersed together with the filler in the first layer film comprise NBR or chloroprene rubber, the content is from 20 to 50 mass % and it includes various kinds of stabilizers and aging inhibitors by 3 to 5 mass %.

Both the electroconductive filler and elastomer are dispersed in the matrix resin by melt kneading with the epoxy resin or the epoxy resin-polyester resin as the matrix resin and the thickness to the surface of the friction member to be coated can be from 10 to 60 μm, preferably, from 15 to 30 μm by mechanical pulverization of them into powdery particles with an average particle size of 10 to 50 μm.

The thermosetting resin as the matrix for the second layer film is the epoxy resin or the epoxy resin-polyester resin like for the first layer film, and includes also those containing an appropriate amount of a hardening agent, a pigment and an anti-blocking agent. The water repellent particles dispersed in the matrix layer include, for example, polytetrafluoroethylene and polytrifluoroethylene. The average particle size is 5 μm or more and the addition amount ranges from 5 to 20 wt %. The powder coating material is prepared in the same manner as that used for the first layer film. The addition amount of the water repellent particles to the epoxy resin or the epoxy resin-polyester resin is from 5 to 30% and, preferably, from 10 to 20% based on the resin.

The thickness of the second layer film is within a range from 10 to 40 μm, preferably, from 10 to 20 μm. Accordingly, it is preferred that the thickness of the coating film is from 15 to 30 μm for the first layer and the thickness of the coating film is from 10 to 20 μm for the second layer.

Since the electroconductivity is provided to the filler in the first layer film, electrostatic powder coating for the second layer can be conducted under usual condition. After forming the first layer film and the second layer film by electrostatic powder coating (corona charging, triboelectric charging system) followed by baking, it is possible to obtain sufficient close adhesion on the side of the pressure plate, coating film strength, corrosion resistance due to development of water repellency at the surface of the coating film, and weather resistance due to elastomer modification. The water repellency can be improved further by applying dense etching by plasma treatment to the surface of the second layer film. In this case, water repellency can be enhanced in proportion to the coarseness.

### EXAMPLE

The present invention is to be described more specifically by way of examples but the range of the invention is not restricted to the examples.

### Example 1

After coating an epoxy type powder coating material blended with 20 mass % of carbon black (200 nm in average) as the electroconductive filler and modified with 40 mass % of NBR as the elastomer by 15 to 20 μm to the surface of a brake pad to be coated after heating by electrostatic powder coating (triboelectric charging system), an epoxy/polyester type powder coating material blended with 15 mass % of polytetrafluoro ethylene as the water repellent particles (5 μm in average) was coated to 15 to 20 μm also by the electrostatic powder coating (triboelectric charging system), and applied with baking at 180° C.×30 min, to prepare a sample for evaluation. Further, the same epoxy type powder coating as in the example 1 (with no NBR (elastomer) modification) was coated by 30 to 40 μm by electrostatic powder coating (triboelectric charging system) and baked at 180° C.×30 min to prepare a sample as a comparative example 1.

Table 1 shows the result of water repellency test and brine water spray test for the example 1 and the comparative example 1.

[Water Repellency Test]

Test Method

Measurement for angle of contact according to a liquid dropping method (θ/2 method): image treatment, liquid sample=water (10 μl, 20° C.)

Test Result

Example=85°, Comparative Example=60°

[Brine Water Spray Test]

Test Method

The coated surface was cross cut and 72 hrs after brine water spray (JIS standard), a cellophane tape was closely adhered to the cross cut portion, the cellophane tape was peeled 10 min after and evaluated according to the following evaluation standards.

The test result is shown in Table 1. In Table 1 “N-1”, etc. indicate sample No.

Test Result

Peeling within 2 mm on one side from the cross cut portion: ◯

Peeling within 5 mm on one side from the cross cut portion: Δ

Peeling for more than 5 mm on one side from the cross cut portion: ×

TABLE 1
Test result of brine water spray

| | Example 1 | Comparative Example 1 |
|---|---|---|
| N = 1 | ◯ | Δ |
| N = 2 | ◯ | Δ |
| N = 3 | ◯ | Δ |

As can be seen from the test result, more excellent effect could be obtained for the examples of the invention with reference to comparative examples in view of water repellency and corrosion resistance.

In the present invention, a multi layers coating films excellent in a corrosion resistance and a weather resistance and having an uniform quality can be obtained in a work to be coated with coating films. Therefore, it is expected that the method to form multi layers coating films is used as a coating method for various metallic members, and the work formed with the multi layers coating films obtained by the method is widely usable in various technical fields. Specifically, in the production of friction members for use in brakes, for example, of automobiles, railway vehicles, and industrial machines, it is expected by practicing the present invention to provide a friction member capable of obtaining products excellent in the corrosion resistance and the close adhesion and having uniform quality, as well as a coating method therefor.

It will be apparent to those skilled in the art that various modifications and variations can be made to the described exemplary embodiments of the present invention without departing from the spirit or scope of the invention. Thus, it is intended that the present invention cover all modifications and variations of this invention consistent with the scope of the appended claims and their equivalents.

What is claimed is:

1. A work to be coated with multi layers of coating films, comprising:
a first layer of coating film formed by coating a powder coating material of a thermosetting resin containing an electroconductive filler and an elastomer on a surface to be coated on the work; and
a second layer of coating film formed by coating a powder coating material of a thermosetting resin containing water repellent particles on the first layer of coating film,
wherein the first layer of coating film and the second layer of coating film are baked by heating.

2. The work according to claim 1, wherein the work is a friction member comprising a metal pressure plate and a friction material.

3. A method of forming multi layers of coating films on an work to be coated, the method comprising:
forming a first layer of coating film by coating a powder coating material of a thermosetting resin containing an electroconductive filler and an elastomer on a surface to be coated on the work;
forming a second layer of coating film by coating a powder coating material of a thermosetting resin containing water repellent particles on the first layer of coating film; and
baking the first layer of coating film and the second layer of coating film by heating.

4. The method according to claim 3, wherein the step of forming the first layer of coating film is conducted by electrostatic coating on the surface of the work by using an epoxy resin type powder coating material containing particles of one or more of metals such as aluminum and zinc, carbon black, and particles of metal oxides such as zinc oxide and titanium oxide as the filler.

5. The method according to claim 3, wherein the step of forming the second layer of coating film is conducted by electrostatic coating on the first layer of the coating film by using an epoxy resin type powder coating material containing one or more of polytetrafluoroethylene and polytrifluoroethylene as the water repellent particles.
